(19) United States
(12) Patent Application Publication
(10) Pub. No.: US 2018/0221895 A1
(43) Pub. Date: Aug. 9, 2018

(54) Rotating Lawn Sprinkler

(71) Applicant: Thomas Leon McCarty, Amarillo, TX (US)

(72) Inventor: Thomas Leon McCarty, Amarillo, TX (US)

(21) Appl. No.: 15/425,386

(22) Filed: Feb. 6, 2017

(51) Int. Cl. B05B 3/02; B05B 3/00; B05B 15/06

(52) U.S. Cl. CPC B05B 3/021; B05B 15/063; B05B 3/003

(57) ABSTRACT

The present invention relates generally to an improved rotating lawn sprinkler capable of precisely watering lawns with straight edges without over-spraying onto sidewalks and fences. More specifically, the invention relates to a rotating sprinkler with a plane of rotation is adjustable upwards or downwards from horizontal that will water in a triangle pattern when the plane of rotation is angled downwards from horizontal or a diamond pattern when the plane of rotation is angled upwards from horizontal. These watering patterns are possible because the axis of rotation is adjustable, which adjusts the plane of rotation. By adjusting the plane of rotation, the nozzle trajectory is being continually increased or decreased as the sprinkler rotates, which causes the watering pattern to form patterns with straight lines rather than traditional watering arcs.

### BACKGROUND OF THE INVENTION

### 1. Field of the Invention

The present invention relates generally to an improved rotating lawn sprinkler capable of precisely watering lawns with straight edges without over-spraying onto sidewalks and fences. More specifically, the invention relates to a rotating sprinkler with a plane of rotation is adjustable upwards or downwards from horizontal that will water in a triangle pattern when the plane of rotation is angled downwards from horizontal or a diamond pattern when the plane of rotation is angled upwards from horizontal.

### 2. Description of Related Art

Traditional rotating lawn sprinklers are well-known in the art. Traditional rotating lawn sprinklers attach to a garden hose and have a nozzle that ejects the water in a trajectory away from the nozzle during irrigation. The sprinklers are movable and rest on a stable base or have a stake for insertion into the ground. As these traditional rotating sprinklers rotate during irrigation on a horizontal plane, the water is ejected creating a partial circular watering arc on the lawn. These sprinklers allow the user to adjust the degree of rotation of the sprinkler from a full 360 degrees down to almost 0 degrees. If the degree of rotation is set at 90 degrees for example, then the watering arc created on the lawn is a quarter circle. If the degree of rotation is set at 180 degrees, then the watering arc created on the lawn is a semi-circle. The radius of these watering arcs (i.e., the maximum distance the water is ejected) is controlled by two factors: the ejection angle of the nozzle and the water pressure. Users easily control the water pressure by adjusting how much they open the house water valve feeding the garden hose, which is the easiest way to adjust the size of the watering arc. Additionally, separate water control valves are available that can be placed between the garden hose and sprinkler for more precise water pressure control. However, if the sprinkler is connected to a source of fixed water pressure, like in the case of an in-ground system connected to pipes and valves, then the only way to adjust the size of the watering arc is to lower the nozzle trajectory (to decrease the size of the watering arc) or raise the nozzle trajectory (to increase the size of the watering arc). One method to adjust the nozzle trajectory is disclosed in U.S. Pat. No. 8,177,148.

The biggest limitation regarding traditional rotating sprinklers is that, due to their circular rotation, the water is only ejected in circular watering arcs on the lawn. However, the lawns of most houses are not circular, but rather have straight edges along fences, sidewalks, streets and houses. Using a traditional rotating sprinkler to water a lawn with straight edges requires either placing the sprinkler in the corner and setting the degree of rotation to rotate from one straight edge of the corner to the other or placing the sprinkler in the middle of the yard and adjusting the watering arc size to minimize over- or under-watering. Both methods have limitations and drawbacks. By placing the sprinkler in the corner, the user can prevent water from spraying onto the sidewalk or fences, but due to the watering arc, to get full coverage of the yard the watering arc will necessarily overlap the watering arc from when the sprinkler is moved to an opposite corner, which wastes water as the middle of the yard receives twice as much water as the edges. If the sprinkler is placed in the middle of the yard, the user must adjust the water trajectory and choose whether to waste water by spraying the sidewalk or fences or under-water by not having the trajectory of the water reach the corner. For example, if the user sets the water trajectory to reach the farthest point away from the middle (i.e., the corner), then as it rotates towards the shorter distances away from the middle (i.e., the sides) the water will over spray onto the sidewalk or fence. Conversely, if the user sets the water trajectory to only reach the shorter distances to avoid over-spray on the sidewalks, then the trajectory will not be sufficient to reach the corner of the yard.

It is therefore desirable to have an improved rotating lawn sprinkler capable of watering lawns with straight edges without overlapping water coverage in the middle or having to choose between over-spray on the sidewalks or not reaching the corners.

### SUMMARY OF THE INVENTION

The present invention provides generally for an improved rotating impact sprinkler where the axis of rotation is adjustable that will water in a triangle pattern when the plane of rotation is angled downwards from horizontal or a diamond pattern when the plane of rotation is angled upwards from horizontal. By adjusting the plane of rotation, the nozzle trajectory is being continually increased or decreased as the sprinkler rotates, which causes the watering pattern to form patterns with straight lines rather than traditional watering arc.

The improved rotating sprinkler consists of a stable base with a hose-attachment inlet. In one embodiment, there is a hollow, adjustable riser, which is in fluid connection with the hose inlet, and extends vertically from the base. In an alternate embodiment, the sprinkler has a straight riser that is adjustable through the use of a hinge or elbow mounted at one point along the riser, preferably at either the base or top of the riser. Attached to the top of the adjustable riser is a rotating sprinkler head, which houses an ejection nozzle that is in fluid communication with the adjustable riser. The degree of rotation of the rotating sprinkler head is adjustable by the use of friction collars with pins. The axis of rotation is adjusted by manipulation of the adjustable riser by bending the riser to point the sprinkler head upwards or downwards. The user can adjust the distance the water travels from the sprinkler by adjusting the water pressure by opening or closing the valve on the hose bib.

In use, when the adjustable riser is straight, the axis of rotation is vertical (90 degrees from horizontal) and the plane of rotation of the sprinkler is horizontal. This set up causes the sprinkler to operate in the traditional way and creates the circular watering arc as water is ejected from the nozzle at the same trajectory for the entire degree of rotation selected. In this instance, if the degree of rotation is set at 90 degrees, then the watering pattern created will be a quarter circle. When the adjustable riser is bent backward, the axis of rotation is changed from vertical and the plane of rotation is angled upward from horizontal. In this instance, if the degree of rotation is set at 90 degrees, the watering pattern created is a diamond pattern wherein the trajectory of water is the shortest at 0 degrees and 90 degrees and the longest at 45 degrees. This setup is used when the sprinkler is placed in a corner of a yard to create a straight watering line along the opposite side of the yard as the trajectory increases as it the sprinkler rotates from 0 degrees to 45 degrees and then decreases as it rotates from 45 degrees to 90 degrees along the other opposite side. When the adjustable riser is bent forward, the axis of rotation is changed from vertical and the plane of rotation is angled downward from horizontal. In this instance, if the degree of rotation is set at 90 degrees, the watering pattern created is a triangle pattern wherein the trajectory of water is the longest at 0 degrees and 90 degrees and the shortest at 45 degrees. This setup is used when the sprinkler is placed in the middle of a yard to create a straight watering line from corner to corner as the trajectory decreases as it the sprinkler rotates from 0 degrees to 45 degrees and then increases as it rotates from 45 degrees to 90.

The novel features and construction of the present invention, as well as additional objects thereof, will be understood more fully from the following description when read in connection with the accompanying drawings.

### BRIEF DESCRIPTION OF THE DRAWINGS

The invention is further described and explained in relation to the following figures of the drawings wherein:

FIG. 1 is a side view of the improved rotating lawn sprinkler with the adjustable riser in a straight vertical configuration causing the plane of rotation of the sprinkler head to be horizontal.

FIG. 2 is a side view of the improved rotating lawn sprinkler with the adjustable riser angled such that it is not in a straight vertical configuration, which is causing the plane of rotation of the sprinkler head to be angled upward from horizontal.

FIG. 3 is a side view of the improved rotating lawn sprinkler with the adjustable riser angled such that it is not in a straight vertical configuration, which is causing the plane of rotation of the sprinkler head to be angled downward from horizontal.

FIG. 4 is a side view of an alternative embodiment of the improved rotating lawn sprinkler with a straight riser that is adjusted by a hinge to be angled such that it is not in a straight vertical configuration, which is causing the plane of rotation of the sprinkler head to be angled upward from horizontal.

FIG. 5 is a side view of an alternative embodiment of the improved rotating lawn sprinkler with a straight riser that is adjusted by a hinge to be angled such that it is not in a straight vertical configuration, which is causing the plane of rotation of the sprinkler head to be angled upward from horizontal.

FIG. 6 is a representation of the watering pattern for the improved rotating lawn sprinkler with the adjustable riser in the configuration shown in FIG. 1.

FIG. 7 is a representation of the watering pattern for the improved rotating lawn sprinkler with the adjustable riser in the configuration shown in FIG. 2.

FIG. 8 is a representation of the watering pattern for the improved rotating lawn sprinkler with the adjustable riser in the configuration shown in FIG. 3.

Like reference numerals are used to describe like parts in all figures of the drawings.

### DESCRIPTION OF THE PREFERRED EMBODIMENTS

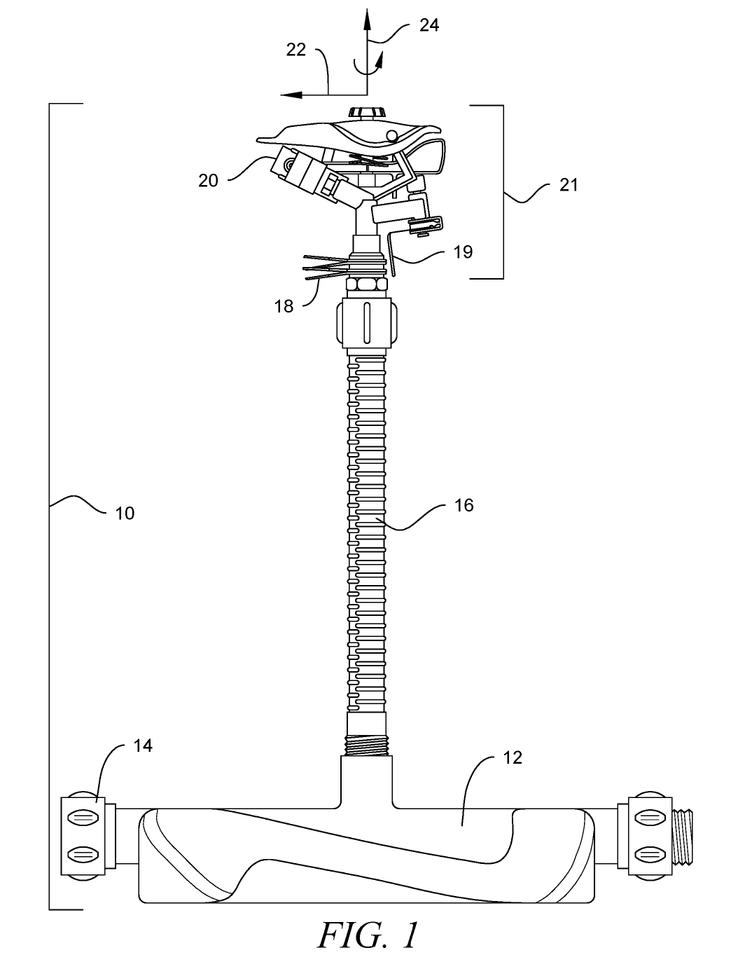

Referring to FIG. 1, improved rotating lawn sprinkler 10 for use in watering lawns and gardens is shown. Lawn sprinkler 10 is comprised of stable base 12, adjustable riser 16, and sprinkler head 21. Stable base 12 preferably includes hose-attachment inlet 14, which is sized to accept and removably thread to a standard garden hose and is in fluid communication with adjustable riser 16. Adjustable riser 16 is preferably formed from a bendable hollow tube that that allows water from the garden hose to pass through and into sprinkler head 21 where it is ejected from nozzle 20. In an alternative embodiment, hose-attachment inlet 14 could be positioned at any point along adjustable riser 16 or above adjustable riser 16 directly on sprinkler head 21 as long as hose-attachment inlet 14 is ultimately in fluid communication with ejection nozzle 20 such that water would pass from the garden hose through the sprinkler 10 and out ejection nozzle 20 when in use.

The pair of rotation friction collars 18 sit atop adjustable riser 16 and directly below sprinkler head 21, which comprises pin 19 and ejection nozzle 20 Sprinkler head 21 is able to rotate independently from base 12, adjustable riser 16 and rotation friction collars 18, which all remain stationary. Rotation friction collars 18 work in conjunction with pin 19 to limit the degree of rotation of sprinkler head 21. One of the pair of rotation friction collars 18 is set at the left-most edge of where the user desires sprinkler 10 to begin its rotation and the other rotation friction collar 18 is set at the right-most edge of where the user desires sprinkler 10 to end its rotation. Pin 19 sits between the pair of friction collars 18 and prevents sprinkler head 21 from rotating past the outer limits the user desired when positioning friction collars 18.

Improved rotating lawn sprinkler 10 is shown in FIG. 1 with adjustable riser 16 in a straight vertical configuration. In this configuration, axis of rotation 24 is vertical, which produces horizontal plane of rotation 22. During watering, this sprinkler configuration operates similar to traditional rotating sprinklers and creates a circular watering arc as water is ejected from ejection nozzle 20 at the same trajectory for the entire desired degree of rotation as sprinkler head 21 moves between rotation friction collars 18. If the user sets the desired degree of rotation at 90 degrees, then the watering pattern created by sprinkler 10 would be a quarter circle.

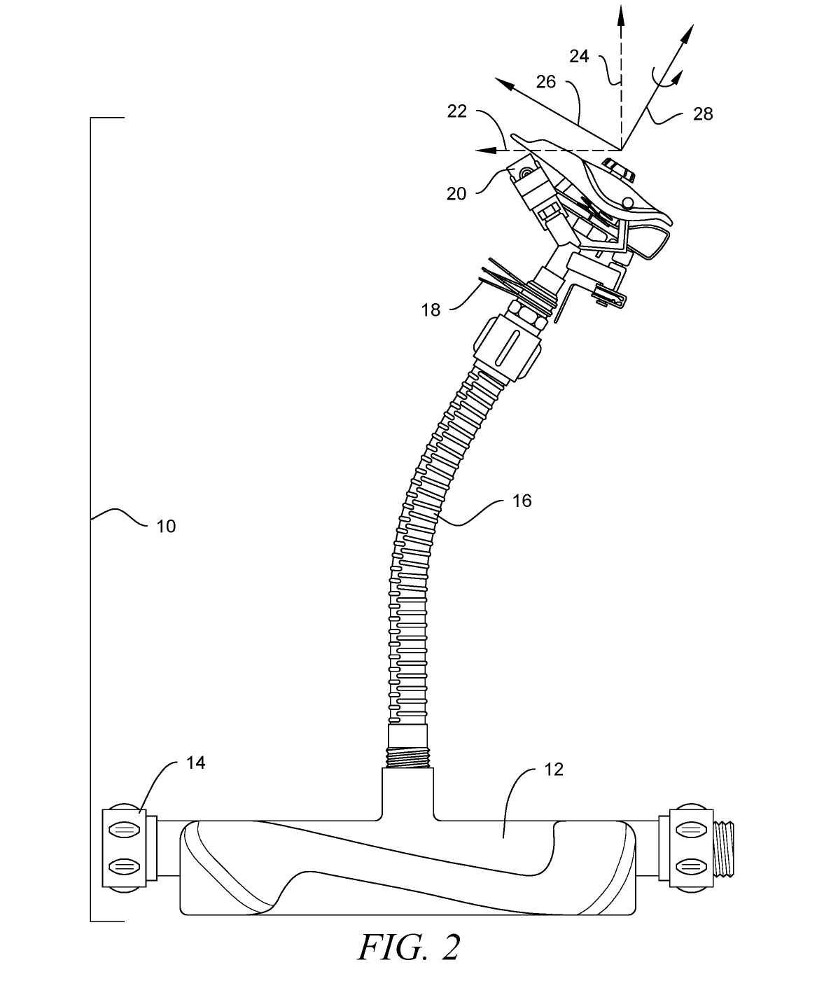

Referring to FIG. 2, improved rotating lawn sprinkler 10 is shown with adjustable riser 16 in an adjusted, non-straight configuration, which causes sprinkler head 21 to be angled upward. When lawn sprinkler 10 is adjusted into this configuration, sprinkler head 21 rotates about axis of rotation 28, which is shifted away from vertical axis of rotation 24 (shown in dashed lines). This creates plane of rotation 26, which is shifted upward from horizontal plane of rotation 22. During watering, this sprinkler configuration does not create a traditional circular watering arc as water is ejected from ejection nozzle 20 at a constantly varying trajectory for the desired degree of rotation as sprinkler head 21 moves between rotation friction collars 18. If the user adjusts adjustable riser 16 into this position and then sets rotation friction collars 18 on either side of ejection nozzle 20 to create a degree of rotation of 90 degrees, then the watering pattern created by sprinkler 10 in this configuration would be diamond-shaped.

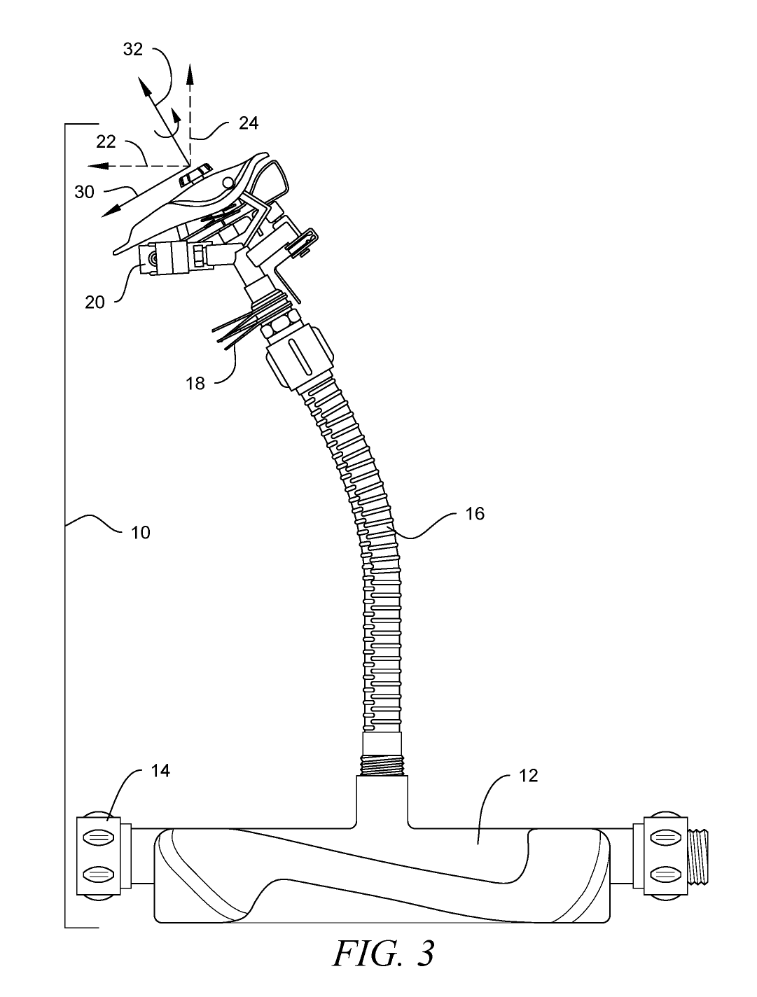

Referring to FIG. 3, improved rotating lawn sprinkler 10 is shown with adjustable riser 16 in an adjusted, non-straight configuration, which causes sprinkler head 21 to be angled downward. When lawn sprinkler 10 is adjusted into this configuration, sprinkler head 21 rotates about axis of rotation 32, which is shifted away from vertical axis of rotation 24 (shown in dashed lines). This creates plane of rotation 30, which is shifted downward from horizontal plane of rotation 22. During watering, this sprinkler configuration does not create a traditional circular watering arc as water is ejected from ejection nozzle 20 at a constantly varying trajectory for the desired degree of rotation as sprinkler head 21 moves between rotation friction collars 18. If the user adjusts adjustable riser 16 into this position and then sets rotation friction collars 18 on either side of ejection nozzle 20 to create a degree of rotation of 90 degrees, then the watering pattern created by sprinkler 10 in this configuration would be triangular-shaped.

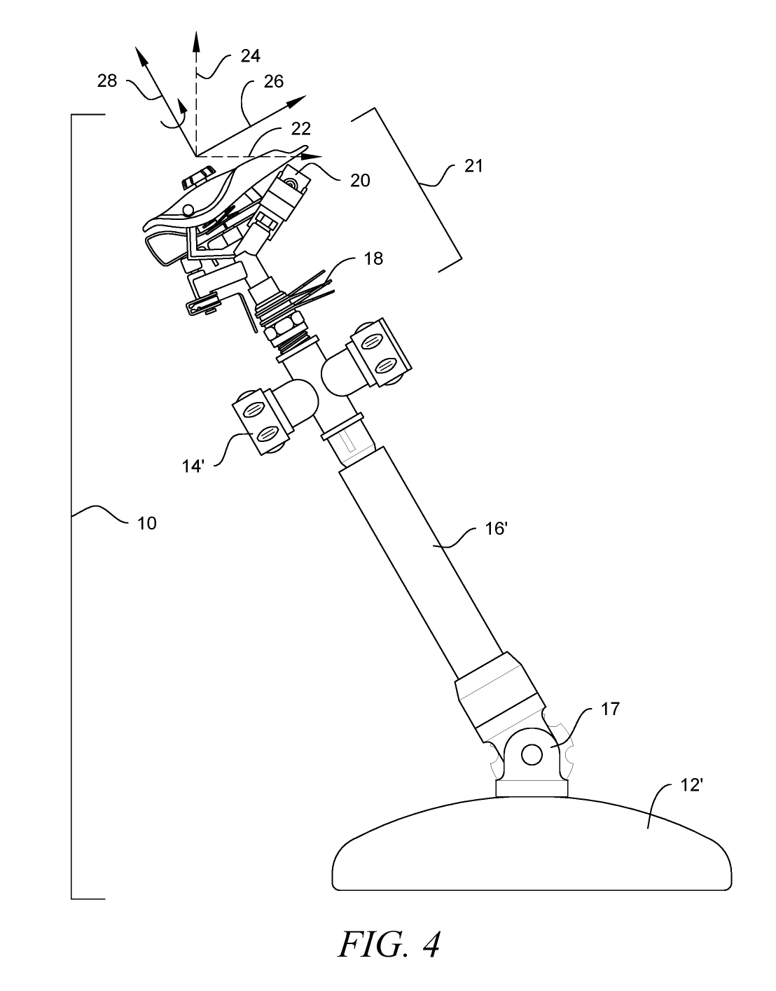

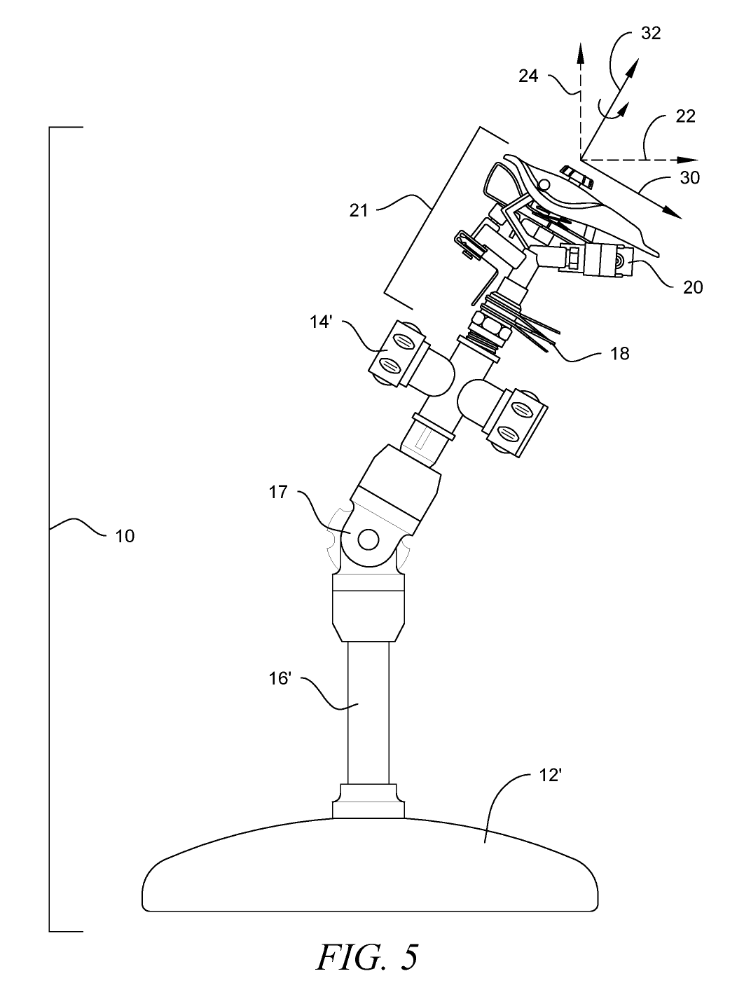

Referring to FIGS. 4 and 5, an alternative embodiment of improved rotating lawn sprinkler 10′ is shown with straight riser 16′ in an adjusted, non-vertical configuration, which causes sprinkler head 21 to be angled upward or downward. In FIG. 4, straight riser 16′ is adjusted through the use of hinge 17 placed between base 12′ and riser 16′. In this embodiment, hose inlet 14′ is located above straight riser 16′, which allows water from the garden hose to pass directly into sprinkler head 21 where it is ejected from nozzle 20. In FIG. 4, straight riser 16′ has been angled through the use of hinge 17 to cause sprinkler head 21 to be angled upward causing sprinkler head 21 to rotate about axis of rotation 32. In FIG. 5, straight riser 16′ is adjusted through the use of hinge 17 placed between riser 16′ and sprinkler head 21. In this embodiment, hose inlet 14′ is located above straight riser 16′, which allows water from the garden hose to pass directly into sprinkler head 21 where it is ejected from nozzle 20. In FIG. 5, straight riser 16′ has been angled through the use of hinge 17 to cause sprinkler head 21 to be angled downward causing sprinkler head 21 to rotate about axis of rotation 28.

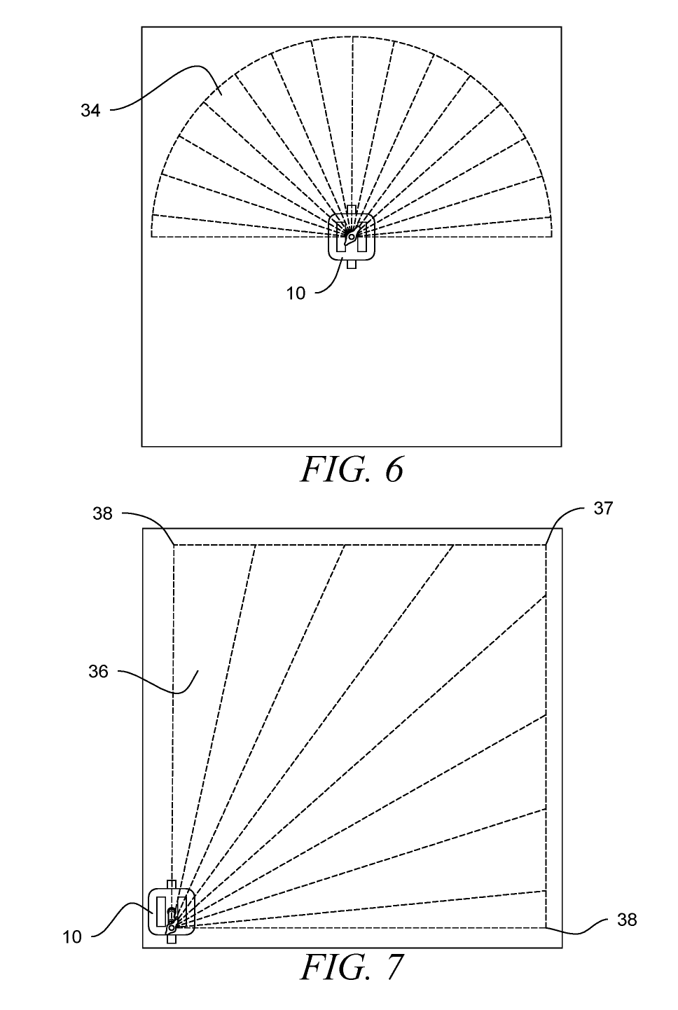

Referring to FIG. 6, improved rotating lawn sprinkler 10 is configured as shown in FIG. 1 with vertical axis of rotation 24 and horizontal plane of rotation 22 and rotation friction collars set to allow 180 degrees of rotation. This configuration creates traditional watering arc 34, which is a half circle because the trajectory of ejection nozzle 20 remains constant in this configuration, the water is ejected the same distance during the entire rotation. As shown in FIG. 6, if the user selects a water pressure to eject water at a distance to not overwater the edges, the corners of the yard receive no water. Conversely (and not shown), if the user selects a water pressure sufficient to reach the corners, then the water will overspray on the edges, which is wasteful.

Referring to FIG. 7, improved rotating lawn sprinkler 10 is configured as shown in FIGS. 2 and 4 with vertical axis of rotation 28 and horizontal plane of rotation 26 and rotation friction collars set to allow 90 degrees of rotation. This configuration creates watering pattern 36, which is diamond-shaped because the trajectory of ejection nozzle 20 does not remain constant in this configuration and the water is not ejected the same distance during the entire rotation. As shown in FIG. 7, the user selects a water pressure sufficient to reach far corner 37 at the highest trajectory of ejection nozzle 20. As sprinkler 10 rotates away from far corner 37 to either adjacent corner 38, the trajectory of ejection nozzle 20 is continually decreasing causing the water to travel a shorter distance, which causes watering pattern 36 to have straight lines. This allows a user to water the entire square yard with no overspray (assuming the yard is sufficiently-sized in that the maximum distance the water can travel is sufficient to reach far corner 37).

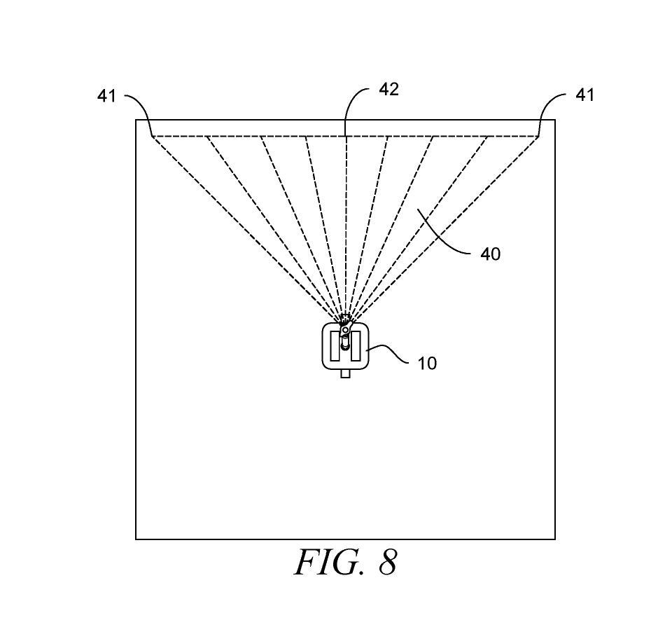

Referring to FIG. 8, improved rotating lawn sprinkler 10 is configured as shown in FIGS. 3 and 5 with vertical axis of rotation 32 and horizontal plane of rotation 30 and rotation friction collars set to allow 90 degrees of rotation. This configuration creates watering pattern 40, which is triangular-shaped because the trajectory of ejection nozzle 20 does not remain constant in this configuration and the water is not ejected the same distance during the entire rotation. As shown in FIG. 8, the user selects a water pressure sufficient to reach near side 42 at the lowest trajectory of ejection nozzle 20. As sprinkler 10 rotates away from near side 42 to either adjacent corner 41, the trajectory of ejection nozzle 20 is continually increasing causing the water to travel a farther distance, which causes watering pattern 40 to have straight lines. This allows a user to water one-quarter of the square yard with no overspray, which would be a preferred configuration if the yard was too large to water with the configuration shown in FIG. 2 with watering pattern 36 shown in FIG. 5. Additionally, this configuration would be useful to water any straight line, even if the other portions of the user's yard were not square.

An additional embodiment of improved rotating lawn sprinkler 10 involves modifying ejection nozzle 20 to be a flat trajectory or zero degree nozzle rather than traditional ejection nozzle 20, which is elevated rather than flat (See e.g., FIG. 1). The zero degree nozzle can be used when improved rotating lawn sprinkler 10 is configured as shown in FIGS. 2 and 4 in order to allow ejected water to travel further than if the traditional elevated nozzle was used.

This concept of modifying rotating sprinklers to allow the axis of rotation to be adjustable has implications greater than just the rotating lawn sprinklers described above. Sprinklers with the same adjustability could be affixed to the end of agricultural center-pivot sprinklers to allow precise watering of crops to the edge of the farmer's land and eliminate the crop circles that have been created by the center-pivot sprinklers. The same concept could be applied to fixed in ground pop-up style sprinklers as well. In an alternative embodiment, rather than be adjustable, the axis of rotation could be fixed at a given angle for use in these fixed, in-ground sprinklers as they would not have to have the ability to change watering patterns between a diamond and triangle as they are not portable. With this embodiment, the user would select a unit with the fixed axis of rotation that would produce the desired watering pattern based on the permanent location of the sprinkler in the yard.

Other alterations and modifications of the invention will likewise become apparent to those of ordinary skill in the art upon reading the present disclosure, and it is intended that the scope of the invention disclosed herein be limited only by the broadest interpretation of the appended claims to which the inventor is legally entitled.

1. A rotating sprinkler comprising:
a horizontally rotating sprinkler head with an axis of rotation and an ejection nozzle;
an inlet for water in fluid communication with the ejection nozzle;
wherein the axis of rotation is adjustable off of vertical to create watering patterns with straight lines.

2. The rotating sprinkler of claim 1 further comprising a stable base.

3. The rotating sprinkler of claim 2 wherein the stable base houses the inlet for water.

4. The rotating sprinkler of claim 3 wherein the inlet for water is a hose-attachment inlet for removably coupling to a hose.

5. The rotating sprinkler of claim 1 further comprising a riser that is adjustable to change the axis of rotation.

6. The rotating sprinkler of claim 1 further comprising a straight riser connected to a hinge wherein the hinge allows the straight riser to be angled which changes the axis of rotation.

7. The rotating sprinkler of claim 1 further comprising rotation friction collars capable of limiting the degree of rotation of the sprinkler head.

8. A rotating sprinkler comprising:
a horizontally rotating sprinkler head with an axis of rotation and an ejection nozzle;
an inlet for water in fluid communication with the ejection nozzle;
wherein the axis of rotation is adjusted off of vertical to create watering patterns with straight lines.
